(19) United States
(12) Patent Application Publication
(10) Pub. No.: US 2010/0053335 A1
(43) Pub. Date: Mar. 4, 2010

(54) SYSTEM AND METHOD FOR MEASURING IMAGE QUALITY OF MOVING PICTURES

(75) Inventors: Seung Seok HONG, Hwasung-si (KR); Ji Tae SHIN, Anyang-si (KR); Yo Han KIM, Sungnam-si (KR); Hyoung Won KWAK, Suwon-si (KR); Poong Up LEE, Suwon-si (KR); Duk Gu SUNG, Suwon-si (KR); Jung Hyun HAN, Seoul (KR); Beom Gon YU, Seosan-si (KR); Young Sang CHO, Cheonan-si (KR)

Correspondence Address: HOLME ROBERTS & OWEN LLP, 1700 LINCOLN STREET, SUITE 4100, DENVER, CO, 80203, US

(73) Assignee: SUNGKYUNKWAN UNIVERSITY FOUNDATION FOR CORPORATE COLLABORATION, Suwon-si (KR)

(21) Appl. No.: 12/367,256

(22) Filed: Feb. 6, 2009

(30) Foreign Application Priority Data
Aug. 29, 2008 (KR) 10-2008-0085221

(51) Int. Cl. H04N 17/00

(52) U.S. Cl. 348/180; 348/E17.001

(57) ABSTRACT

The present invention relates to a system for measuring image quality of moving pictures. The system comprises a transmitter, for transmitting encoded image data through a channel, and a receiver, for receiving the encoded image data and analyzing image information from the received image data to measure the image quality of moving pictures. The receiver includes a reception data input unit for receiving the encoded image data, a reception information analysis unit for analyzing a bitstream from the received image data in order to extract image information including loss or non-loss, a motion vector, and coordinates of each block, and an image quality measurement unit for applying a weight to each block by using the extracted image information and calculating the number of lost blocks reflecting weights to measure image quality.

### TECHNICAL FIELD

The present invention relates to a system and method for measuring image quality of moving pictures, in which a weight is applied to each block constituting a received image according to the coordinates at which the image is located and a region in which an object exists, and the number of lost blocks in each region is calculated, thereby measuring image quality in terms of image recognition.

### BACKGROUND

As image quality measurement is a core technology for image transmission quality measurement as well as for performance verification of video codecs and development of new compression coding schemes, the importance of image quality measurement is being emphasized more and more. Until now, image quality measurement has been subjectively carried out by a plurality of evaluators. Such a scheme has many restrictions and limitations in terms of time and cost, and is very inefficient due to the impossibility of real-time evaluation.

As mentioned above, a transmission error becomes an important factor in image transmission quality measurement. Examples of transmission errors that may be generated in digital communication include packet loss, a block error, a bit error, time delay, jitter, overflow indicating an excess of the capacity of a buffer, underflow indicating emptiness of the buffer, and the like. A transmission error results in frame loss, image quality degradation mainly caused by packet loss/block error, frame delay, and so forth.

Image quality monitoring methods can be classified as a full reference method, a reduced reference method, a no reference method, and the like. The full reference method is known as the most accurate image quality measurement method because it uses both a reference image and a processed image. However, the full reference method requires the reference image, which limits its practical application. The reduced reference method extracts a plurality of parameters from a reference image and transmits the extracted parameters together with image data to a receiver. The receiver then extracts parameters from the received image data and compares the extracted parameters with received parameters, thereby measuring image quality. Since such additional parameters are also transmitted, the reduced reference method requires extra bandwidth in a downstream channel, which is a significant drawback to this method.

Although the no reference method has low accuracy because it performs image quality evaluation with only a processed image resulting from decoding without any reference image information, it is mainly used in video quality estimation by analyzing a bitstream included in a Moving Picture Experts Group (MPEG)-2 Transport Stream (TS).

As such, among the conventional objective image quality evaluation methods, the full reference method and the reduced reference method have the disadvantage of requiring additional data transmission and the no reference method has the problem of low accuracy. The image quality monitoring method used in a receiver is very important given that an error rate is high in image services using wireless communication channels, but the current technology has many problems in its practical use. Therefore, considering that image quality monitoring is emerging as an important issue, a new image quality measurement method is required.

### Technical Problem

Accordingly, the present invention is intended to solve the foregoing problems of the prior art and an object of the present invention is to provide a system and method for measuring image quality of moving pictures in which image quality at a reception end can be measured by image recognition using a weight, which is based on transmission loss information and an interest level.

### Technical Solution

According to one aspect of the present invention, there is provided a system for measuring image quality of moving pictures, comprising a transmitter for transmitting encoded image data through a channel and a receiver for receiving the encoded image data and analyzing image information from the received encoded image data to measure image quality of moving pictures. The receiver includes a reception data input unit for receiving the encoded image data, a reception information analysis unit for analyzing a bitstream from the received image data to extract image information including loss or non-loss, a motion vector, and coordinates of each block, and an image quality measurement unit for applying a weight to each block by using the extracted image information and calculating the number of lost blocks reflecting weights to measure image quality.

According to another aspect of the present invention, there is provided a method for measuring image quality of moving pictures. The method includes an image data reception step of receiving encoded image data through a channel, a reception information analysis step of analyzing a bitstream from the received image data to extract image information including loss or non-loss, a motion vector, and coordinates of each block, and an image quality measurement step of measuring image quality by calculating the number of lost blocks reflecting weights with the use of the extracted image information for each block.

### EFFECTS OF THE INVENTION

As described above, the system and method for measuring image quality of moving pictures according to the present invention is an image quality measurement technique which analyzes received image data to use, for each block, a weight reflecting image information and an image recognition aspect. In the present invention, the weight for each block is calculated according to an interest level based on a human visual system (HVS), thereby quickly extracting the quality of an image being output at a reception end as an image recognition value.

### BRIEF DESCRIPTION OF THE DRAWINGS

FIG. 1 is a block diagram schematically illustrating the structure of a receiver in a system for measuring image quality of moving pictures according to an embodiment of the present invention;

FIG. 2 illustrates slices of received data according to an embodiment of the present invention;

FIG. 3 is a diagram for explaining motion vector calculation for slices according to the present invention;

FIG. 4 illustrates a motion vector of each block according to the present invention;

FIGS. 5A and 5B are diagrams for explaining weight applying and adjustment methods based on an interest level according to an embodiment of the present invention;

FIG. 6 is a flowchart schematically illustrating a method for measuring image quality of moving pictures according to an embodiment of the present invention; and

FIG. 7 is a flowchart illustrating in detail the method for video quality evaluation according to the embodiment of the present invention.

### DETAILED DESCRIPTION OF THE INVENTION

### Mode for Carrying Out the Invention

A system for measuring image quality of moving pictures according to one aspect of the present invention, which uses a weight per region of interest, includes a transmitter for transmitting encoded image data through a channel and a receiver for receiving the encoded image data and analyzing image information from the received encoded image data to measure image quality of moving pictures. The receiver includes a reception data input unit for receiving the encoded image data, a reception information analysis unit for analyzing a bitstream from the received image data and extracting image information including loss or non-loss, a motion value, and coordinates of each block, and an image quality evaluation unit for applying a weight to each block by using the extracted image information and calculating the number of lost blocks reflecting weights, to measure image quality.

Hereinafter, a system and method for measuring image quality of moving pictures according to the present invention will be described in detail with reference to the accompanying drawings.

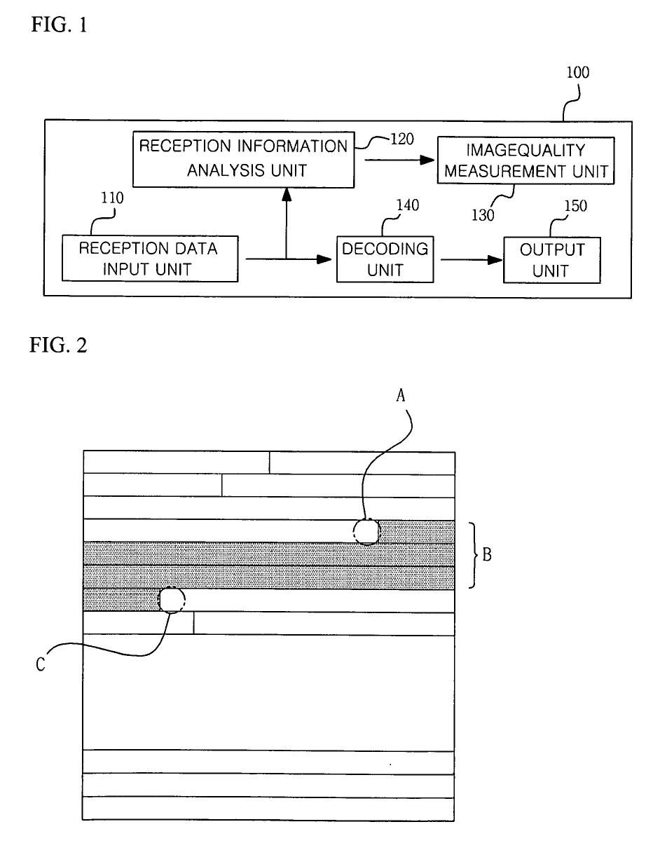

FIG. 1 is a block diagram schematically illustrating the structure of a receiver 100 of a system for measuring image quality of moving pictures according to an embodiment of the present invention. The receiver 100 may include a reception data input unit 110, a reception information analysis unit 120, an image quality measurement unit 130, a decoding unit 140, and an output unit 150.

In the system for measuring image quality of moving pictures which includes a transmitter for transmitting encoded image data through a channel and the receiver 100 for receiving the encoded image data and analyzing image information from the received encoded image data to measure image quality of moving pictures, the reception data input unit 110 receives the encoded image data through the channel and transmits the received image data to the reception information analysis unit 120 and the decoding unit 140.

The decoding unit 140 decodes the received encoded image data to generate a reception image and displays the generated reception image on the output unit 150. The reception information analysis unit 120 analyzes a bitstream from the received image data to extract image information including loss or non-loss, a motion vector, and coordinates of each block.

Herein, extraction of loss or non-loss of each block involves detecting a lost block by comparing position information of blocks in the received image data, in which the image data has been compressed in the unit of a block at the transmitter for transmission of the image data. For example, when a quarter common intermediate format (QCIF) image is compressed, a total of 99 blocks having unique position information of 0-98 are generated, so if the position information of the block after a block having position information of 56 is 59, then 2 blocks have been lost and thus loss of information included in the blocks having position information of 57 and 58, respectively, can be extracted.

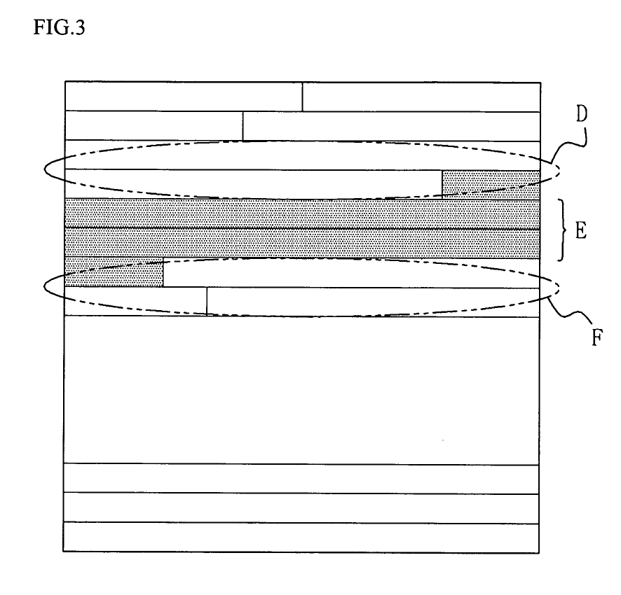

FIG. 2 illustrates slices of received data according to an embodiment of the present invention, in which slices of a region B are lost during transmission.

In general, data transmission is performed in the unit of a slice, and each slice is composed of several blocks. For this reason, loss occurring during data transmission can be estimated from position information of the last block of the previous slice and position information of the first block of the next slice. In other words, the position information of the last block of the previous slice and the position information of the first block of the next slice have a difference of “+1” when no loss occurs during data transmission, whereas they would have a difference of “+2” or more if loss occurs during data transmission. Thus, information about data loss occurring during transmission of image data can be extracted by using position information of blocks. As illustrated in FIG. 2, if a slice of region A is received, the slices of the region B are lost during transmission, and a slice of a region C is received, position information of the last block of the slice of the region A and position information of the first block of the slice of the region C would have a difference of “+2” or more, based on which the number of lost blocks can be calculated.

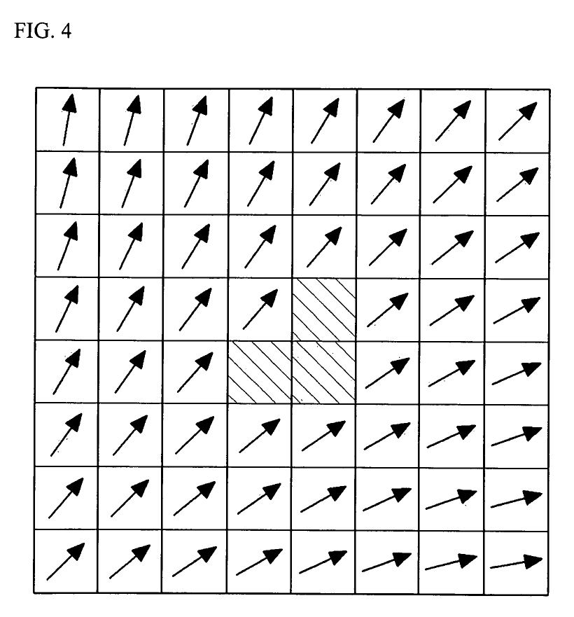

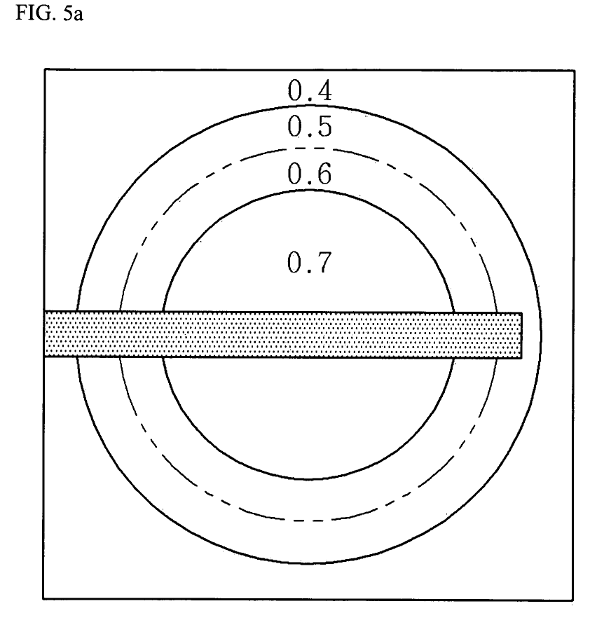

In the image information of the received image data, a motion vector of each block includes a motion value of each block. To extract a moving object in the entire image, the distribution of motion values with respect to the center of an image is extracted, motion values having a uniform size are grouped into each cluster, and then edge extraction is performed for each cluster to find out the contour of an object. A motion vector (motion direction and motion value) of a lost block can be calculated by a pre-programmed algorithm, and in an embodiment, it may be analyzed as an average of a motion vector (value) of a previously received block (or previous block) and a motion vector (value) of a next received block (or next block). The process of calculating a motion vector of a lost block may begin with calculating the amount and direction of change of motion vectors of successively received slices, as illustrated in FIG. 3. That is, a motion vector of a lost slice E can be estimated as an average and an average moving direction of a motion vector of a slice D received before the slice E and a motion vector of a slice F received after the slice E. FIG. 4 illustrates a motion vector of each block. Referring to FIG. 4, the motion vectors of the lost blocks (dashed blocks) can be calculated from motion vectors of blocks received before/after the lost blocks. Thus, once the motion vectors of the lost blocks are estimated, motion vectors in the entire image can be estimated. A moving object exists in a portion where a change in motion vector is large. Since an interest level for a block constituting the moving object is high in light of recognition, a large weight may be applied to the block forming the moving object.

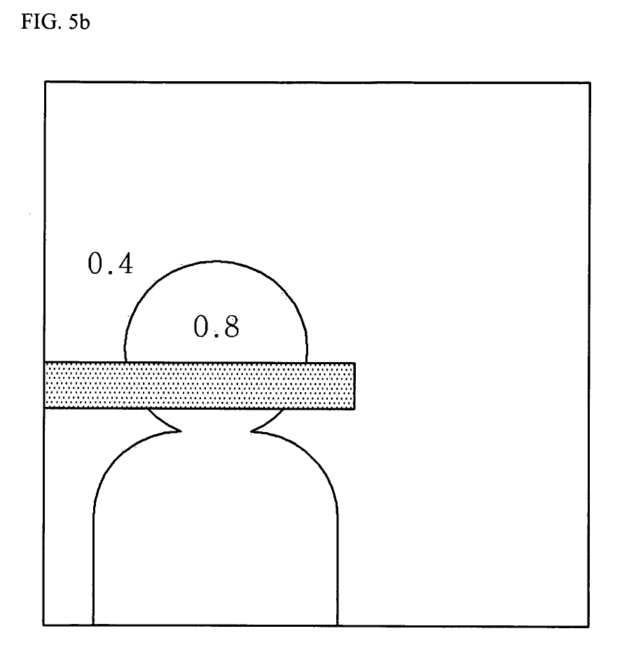

FIGS. 5A and 5B illustrate a weight applying method according to an embodiment of the present invention.

The image quality measurement unit 130, by using the image information extracted by the reception information analysis unit 120, applies a weight to each block according to coordinates of the block based on an interest level in terms of image recognition, and may adjust the applied weight of the block, taking into consideration a motion value of each block. The image quality measurement unit 130 calculates the distance of coordinates of each block, extracted by the reception information analysis unit 120, from the central region of the entire image screen along a concentric direction, and applies sequentially smaller weights to blocks located farther from the central region. This weight applying method may be set such that the entire image is divided into several regions in the concentric direction with respect to the central region of the image, and the same weight is applied to blocks of the same region or different weights are applied to blocks of the same region. For example, since the central region of received image data plays an important role in image quality measurement in terms of image recognition, a weight of “0.7” may be applied to blocks in the central region, whereas sequentially smaller weights such as “0.6”, “0.5”, and the like may be applied to outer blocks located outside the central region along the concentric direction.

The image quality measurement unit 130 may adjust the weight applied to each block, taking into account a motion value obtained from the reception information analysis unit 120. In general, the image of moving pictures is based on a moving object whose interest level is high in light of recognition, for which it is necessary to extract the moving object for reflection in image quality measurement. If a change in motion value between received blocks is large, it can be estimated that a moving object exists in the corresponding blocks, and thus a weight for a block constituting the moving object may be adjusted to a large value.

For example, to extract a moving object in the entire image, the distribution of motion vectors with respect to the center of the image is extracted, blocks having motion values of a uniform size are grouped into each cluster, the contour of an object is extracted by edge extraction for each cluster, and the direction of movement of the object is obtained by analyzing the direction of change of a motion vector of each block. Weight adjustment may be performed for each block, such that among blocks to which sequential weights are applied by the image quality measurement unit 130, a block constituting the object has a larger weight than a block having coordinates included in the central region of the entire image. If a plurality of objects are included in the image, larger weights may be applied to objects having larger motion vectors. For example, as illustrated in FIGS. 5A and 5B, if a block in the central region is “0.7” and an object exists at coordinates corresponding to a weight of “0.4”, the weight of a block in which the object exists may be adjusted to “0.8”.

As mentioned above, adjustment of the weight for a block constituting a moving object may be set such that if a plurality of objects are extracted, larger weights are applied to objects having larger motion vectors.

The image quality measurement unit 130 calculates a weight and measures image quality by calculating a weight per region and the number of lost blocks included in the region or by calculating the number of lost blocks included in a region in which the weight per region is larger than a preset value.

A method for measuring image quality of moving pictures according to another aspect of the present invention includes a image data reception step of receiving image data through a channel, a reception information analysis step of analyzing a bitstream from the received image data to extract image information including loss or non-loss, a motion value, and coordinates of each block, and an image quality measurement step of measuring image quality by calculating the number of lost blocks reflecting weights with the use of the image information extracted for each block.

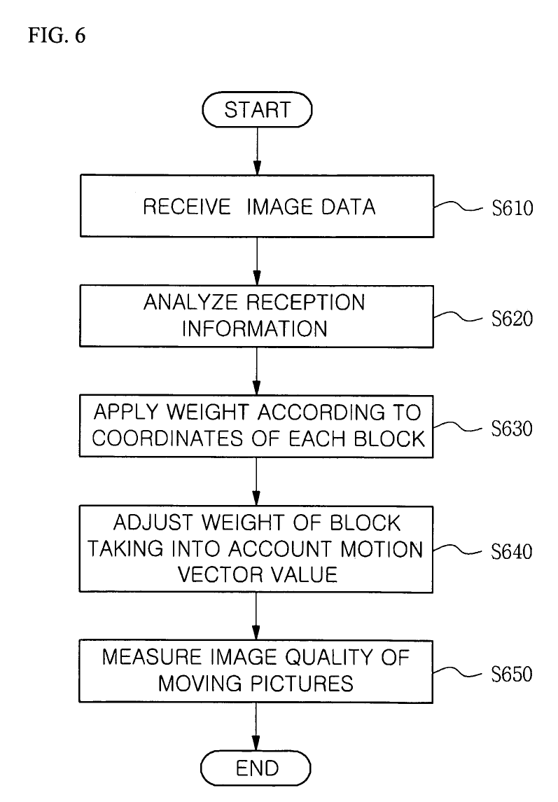

FIG. 6 is a flowchart schematically illustrating a method for measuring image quality of moving pictures according to an embodiment of the present invention, in which the method includes an image data reception step S610, a reception information analysis step S620, a weight applying step S630 of applying a weight according to coordinates of each block, a weight adjustment step S640 of adjusting the weight of each block taking into consideration a motion vector value (motion value), and an image quality measurement step S650.

In the method for measuring image quality of moving pictures according to the present invention, once encoded image data is received through a channel in step S610, image information including loss or non-loss, a motion value, and coordinates of each block is extracted from the received encoded image data in step S620, and a weight is applied according to the coordinates of each block by using the extracted image information of each block in step S630. After the weight applied to each block is adjusted taking account of the motion value in step S640, image quality is measured by calculating the number of lost blocks reflecting the weights in step S650. The foregoing weight applying method is based on an interest level in terms of image recognition, in which weights for blocks constituting the central region and an object in an image are set large for use in image quality measurement.

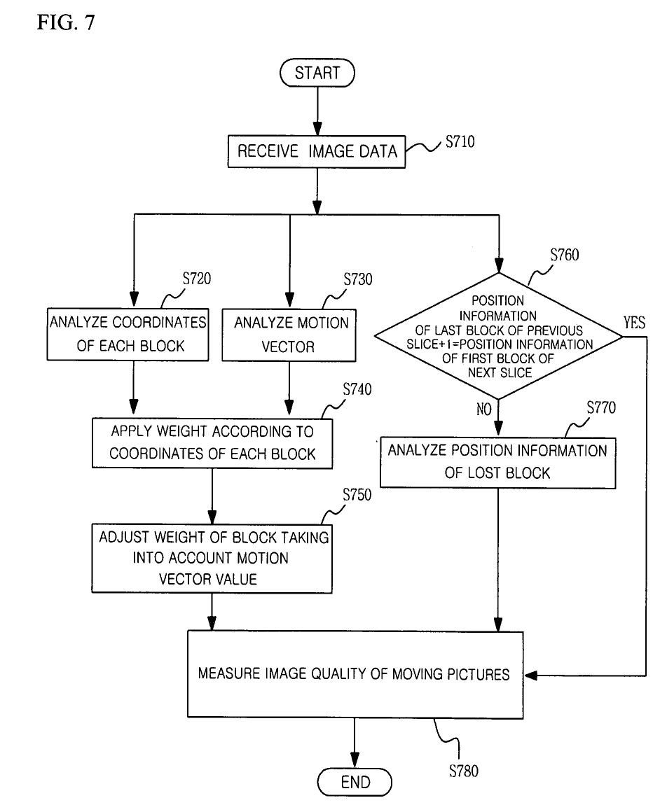

FIG. 7 is a flowchart illustrating in detail the method for measuring image quality of moving pictures according to the embodiment of the present invention, in which reception information is analyzed from the received image data.

Upon reception of image data in step S710, coordinates of each block are extracted in order to find out in which region of the entire image a block constituting a received slice is included in step S720, a motion vector value of each block is analyzed in step S730, and then position information of a block lost during transmission is extracted in step S760. For analysis of the position information of the lost block in step S770, the number and position information of lost blocks may be detected by comparing position information of blocks of the received image data. Since a transmission end compresses image data in the unit of a block and transmits the image data in the unit of a slice composed of one or more blocks, position information of received blocks are assigned successive natural numbers. Thus, if a block is lost during transmission, discontinuity occurs in the position information of the blocks. In other words, for the analysis of the position information of the lost block, position information of a previously received block (or previous block) and position information of a next received block (next block) are compared and if they have a difference of +2 or more, it is detected that one or more blocks have been lost between the compared blocks.

Considering the fact that during image capturing, a subject in a central region of a screen is focused or a moving object is focused, a weight may be determined according to an interest level in terms of image recognition through analysis of coordinates and a motion vector of each block. That is, the central region and a moving object are extracted from a received image and a larger weight is applied to a block constituting the central region or the moving object while a smaller weight is applied to a block constituting a background or a non-moving object. In this way, a weight is adjusted for each region in step S750 for use in image quality measurement in step S780.

The weight applying method and the weight adjustment method for each block have already been described with reference to FIGS. 5A and 5B.

The method for measuring image quality of moving pictures using weights can be embodied as a computer program, and codes and code segments constituting the program can be easily construed by computer programmers skilled in the art. Also, the program can be stored in a computer-readable recording medium and read and executed by a computer to implement the method for measuring image quality of moving pictures. Examples of the computer-readable recording medium include magnetic recording media, optical recording media, and carrier wave media.

The embodiments of the present invention have been described for illustrative purposes only, and it will be understood by one of ordinary skill in the art that various modifications, changes, and additions may be made thereto without departing from the spirit and scope of the present invention. All such modifications, changes, and additions should be regarded as being within the scope of the appended claims.

What is claimed is:

1. A system for measuring image quality of moving pictures, comprising:
a transmitter for transmitting encoded image data through a channel and a receiver for receiving the encoded image data and analyzing image information from the received image data to measure image quality of moving pictures;
wherein the receiver comprises:
a reception data input unit for receiving the encoded image data;
a reception information analysis unit for analyzing a bitstream from the received image data to extract image information including loss or non-loss, a motion vector, and coordinates of each block; and
an image quality measurement unit for applying a weight to each block by using the extracted image information and calculating a number of lost blocks reflecting weights to measure image quality of moving pictures.

2. The system of claim 1, wherein the reception information analysis unit extracts position information of each block of the received image data to detect position information and the number of lost blocks.

3. The system of claim 2, wherein the reception information analysis unit compares position information of a last block of a previously received slice with position information of a first block of a next received slice to calculate the number of lost blocks from the difference between the position information of the last and first blocks, and extracts the position information of lost blocks from the position information of missing blocks between the last and first blocks.

4. The system of claim 1, wherein the reception information analysis unit extracts a distribution of motion vectors with respect to a center of an image, groups motion vectors having a uniform size into clusters, and extracts a contour of an object through edge extraction for each cluster.

5. The system of claim 1, wherein the image quality measurement unit applies a largest weight to a block having coordinates included in a central region of an image and applies sequentially smaller weights to blocks located in a concentric direction with respect to the block, and adjusts the weight of each block constituting the image taking into account a motion value of each block.

6. The system of claim 5, wherein if a plurality of objects are extracted by the reception information analysis unit, the image quality measurement unit applies sequentially larger weights to objects having larger motion vectors.

7. The system of claim 6, wherein by using a weight applied to a block adjacent to a lost block extracted by the reception information analysis unit, the image quality measurement unit estimates the weight of the lost block.

8. The system of claim 6, wherein the image quality measurement unit evaluates image quality by using the number and weights of lost blocks.

9. A method for measuring image quality of moving pictures, the method comprising:
an image data reception step of receiving encoded image data through a channel;
a reception information analysis step of analyzing a bitstream from the received data to extract image information including loss or non-loss, a motion vector, and coordinates of each block; and
an image quality measurement step of measuring image quality by calculating a number of lost blocks reflecting weights by using the extracted image information for each block.

10. The method of claim 9, wherein the reception information analysis step comprises extracting position information of each block of the received image data to detect position information and the number of lost blocks.

11. The method of claim 10, wherein the reception information analysis step comprises comparing position information of a last block of a previously received slice with position information of a first block of a next received slice to calculate the number of lost blocks from a difference between the position information of last and first blocks, and extracting the position information of lost blocks from the position information of missing blocks between the last and first blocks.

12. The method of claim 9, wherein the reception information analysis step comprises extracting a distribution of motion vectors with respect to a center of an image, grouping motion vectors having a uniform size into clusters, and extracting a contour of an object through edge extraction for each cluster.

13. The method of claim 9, wherein the image quality measurement step comprises applying a largest weight to a block having coordinates included in a central region of an image and applying sequentially smaller weights to blocks located in a concentric direction with respect to the block, and adjusting the weight of each block constituting the image, taking into account a motion value of each block.

14. The method of claim 13, wherein the image quality measurement step comprises adjusting the weight of each block such that among blocks to which sequential weights are applied, a block constituting an object has a larger weight than a block having coordinates included in the central region of the image.

15. The method of claim 12, wherein the image quality measurement step comprises applying, for motion values grouped into one or more clusters, sequentially larger weights to clusters having larger motion vectors.

16. The method of claim 9, wherein the image quality measurement step comprises using a weight applied to each block adjacent to an extracted lost block to estimate the weight of the extracted lost block.

17. The method of claim 9, wherein the image quality measurement step comprises evaluating image quality by using the number and weights of lost blocks.

18. A computer-readable recording medium having recorded thereon a program for executing the method for measuring image quality of moving pictures of claim 9.
